(19) United States
(12) Patent Application Publication
(10) Pub. No.: US 2010/0118212 A1
(43) Pub. Date: May 13, 2010

(54) Multimedia Playing Method and Multimedia Playing Device Thereof

(75) Inventor: Hung-Chi Huang, Hsinchu Hsien (TW)

Correspondence Address: EDELL, SHAPIRO & FINNAN, LLC, 1901 RESEARCH BOULEVARD, SUITE 400, ROCKVILLE, MD, 20850, US

(73) Assignee: MSTAR SEMICONDUCTOR, INC., Hsinchu Hsien (TW)

(21) Appl. No.: 12/582,770

(22) Filed: Oct. 21, 2009

(30) Foreign Application Priority Data
Nov. 13, 2008 (TW) 097143852

(51) Int. Cl. H04N 5/60

(52) U.S. Cl. 348/738; 348/E05.122

(57) ABSTRACT

In a multimedia playing device, a type of a TV program included in a received multimedia signal is determined by analyzing various kinds of channel information or image characteristics included in the multimedia signal. When an automatic audio adjusting mode is activated, an appropriated audio mode for the type is retrieved from an audio mode database to play the multimedia signal. The automatic audio adjusting mode of the multimedia playing device allows better flexibility for a viewer in choosing an audio mode. Therefore, the observer is able to choose between a predetermined audio mode of the received multimedia signal and a preferred audio mode meeting needs of the viewer in listening to the played multimedia signal.

### CROSS REFERENCE TO RELATED PATENT APPLICATION

This patent application is based on Taiwan, R.O.C. patent application No. 97143852 filed on Nov. 13, 2008.

### FIELD OF THE INVENTION

The present invention relates to a multimedia playing method and a multimedia playing device thereof, and more particularly, to a multimedia playing method capable of playing a multimedia signal stream according to user requirements and program information included in a received multimedia signal, and a multimedia playing device thereof.

### BACKGROUND OF THE INVENTION

Generally speaking, a cable television (TV) or digital broadband TV system provider, that provides programs to households, transmits multimedia signals to subscribers using an audio mode provided by the channels. Therefore, when the cable TV or the digital broadband TV plays multimedia signals of different channels, audio playing quality is rather different according to different channels or types of programs. With respect to hardware, an equalizer inside a TV is directly altered to change a frequency response of an audio signal to further enhance or weaken a signal having a predetermined frequency and obtain expected audio playing quality. However, audio playing quality of different channels may vary. When the frequency response is changed via the equalizer, the signal having the predetermined frequency may be erroneously enhanced or weakened, and hence the audio playing quality may actually deteriorate and the expected audio playing quality is not achieved.

### SUMMARY OF THE INVENTION

In order to solve the problem of the prior art, a TV program playing method capable of selecting a preferred audio mode according to TV program information to be played and a TV program playing system thereof are provided.

A multimedia playing method of adjusting an audio mode according to a TV program is provided. The multimedia playing method comprises steps of receiving a multimedia signal comprising a TV program, analyzing the multimedia signal to obtain program information related to the TV program, retrieving an audio mode from an audio mode database according to the program information, processing the multimedia signal according to the audio mode, and playing the processed multimedia signal.

A multimedia playing device capable of adjusting an audio mode according to a TV program is provided. The multimedia device comprises a receiver, an information analyzer, an audio mode database, an audio processing circuit, and a playing unit. The receiver receives a multimedia signal comprising a TV program. The information analyzer, coupled to the receiver, analyzes the multimedia signal to obtain program information related to the TV program. The audio mode database, coupled to the information analyzer, generates an audio mode according to the program information. The audio processing circuit, coupled to the receiver and the audio mode database, processes the multimedia signal according to the audio mode. The playing unit, coupled to the audio processing circuit, plays the processed multimedia signal.

The automatic audio adjusting mode according to the present invention provides a viewer with better flexibility in choosing an audio mode, such that the viewer is able to choose between a predetermined audio mode of the multimedia signal and a preferred audio mode that meets the view's needs in listening to the played multimedia signal as provided by the invention.

### BRIEF DESCRIPTION OF THE DRAWINGS

FIG. 1 is a schematic diagram of a multimedia playing device in accordance with the present invention.

FIG. 2 is a flow chart of a multimedia playing method in accordance with the present invention.

### DETAILED DESCRIPTION OF THE PREFERRED EMBODIMENT

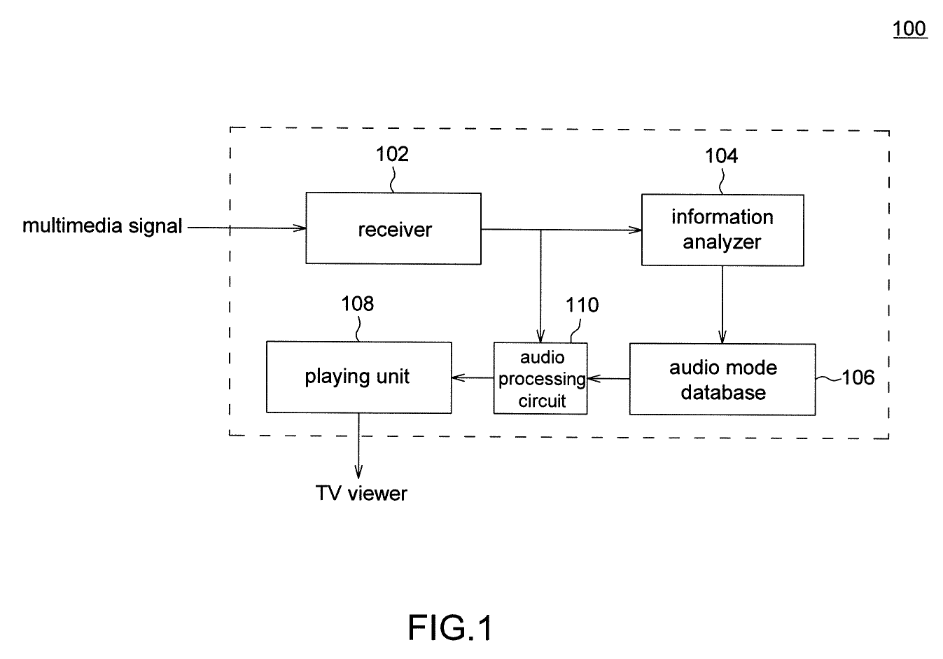

FIG. 1 shows a schematic diagram of a TV program playing system in accordance with the present invention. A TV program playing system 100 comprises a receiver 102, an information analyzer 104, an audio mode database 106, a playing unit 108, and an audio processing circuit 110. In a preferred embodiment of the present invention, the receiver 102 is a multimedia signal stream receiver for receiving an input of a multimedia signal comprising a TV program. The playing unit 108 is a multimedia playing device for playing the multimedia signal processed by the audio processing circuit 110. The audio processing circuit 110 is an equalizer in a preferred embodiment. The information analyzer 104, coupled to the receiver 102, analyzes the multimedia signal received by the receiver 102 to obtain program information related to the TV program. The audio mode database 106, coupled to the information analyzer 104, generates an audio mode according to the program information. The audio processing circuit 110, coupled to the receiver 102 and the audio mode database 106, processes the multimedia signal according to the audio mode generated from the audio mode database 106. The playing unit 108, coupled to the audio processing circuit 110, plays the multimedia signal processed by the audio processing circuit 110. The audio processing circuit 110 equalizes a frequency response corresponding to the audio mode and processes the multimedia signal according to the frequency response.

After the receiver 102 receives the multimedia signal, the information analyzer 104 analyzes the multimedia signal comprising various kinds of playing related channel information, such as a channel number, a channel name, service information, and an image characteristic corresponding to a multimedia signal stream. The characteristics obtained by the information analyzer 104 are provided to play the TV program included in the multimedia signal for reference. For example, when the channel of the TV program corresponding to the multimedia signal is a sports channel or a movie channel, characteristics related to the sports channel or the movie channel are found in the playing related information included in the multimedia signal. A frequency response of a sports program or a movie program is determined according to the characteristics to play the TV program included in the multimedia signal, so that audio quality perceived by a viewer is greatly improved. In the foregoing characteristics, the channel number, the channel name, the service information are intuitive characteristics for learning the type of the TV program. When the audio mode is determined according to the image characteristic, a channel identification trademark displayed in an image of TV program information is used for determining a corresponding channel. Generally, well-known TV program channels place the channel identification trademark at a predetermined position when a TV program is played. For example, a well-known sports channel called the Entertainment and Sports Programming Network (ESPN), or a well-known movie channel called the Home Box Office (HBO), places the channel identification trademark at a predetermined position of an image when a TV program is played. The image having the channel identification trademark is identified via an optical character recognition (OCR) technology according to the present invention. The channel identification trademark is compared with a predetermined trademark, and accordingly an appropriate audio mode is chosen to play the TV program according to a multimedia playing method of the present invention.

The audio mode database 106, stored with a plurality of audio modes, retrieves an audio mode corresponding to the TV program analyzed by the information analyzer 104. The retrieved audio mode is provided to the audio processing circuit 110 for processing the multimedia signal. The audio processing circuit 110 then processes the multimedia signal according to the audio mode generated from the audio mode database 106. The audio processing circuit 110 equalizes a frequency response corresponding to the audio mode and processes the multimedia signal according to the frequency response. The playing unit 108 plays the TV program included in the multimedia signal according to the multimedia signal processed by the audio processing circuit 110.

In a preferred embodiment of the present invention, a multimedia playing device 100 has an automatic audio adjusting mode. When the automatic audio adjusting mode is activated, the multimedia playing device 100 plays the TV program included in a processed multimedia signal according to the foregoing steps. When the automatic audio adjusting mode is deactivated, the foregoing steps are skipped, and the multimedia signal is directly played by a predetermined audio mode of the received multimedia signal. That is to say, a user determines whether to activate the automatic audio adjusting mode according to one's needs to listen to the processed multimedia signal, or to accept the predetermined audio of the multimedia signal.

For instance, when the automatic audio adjusting mode is activated and the TV program of the TV program information is a sports program, the audio processing circuit 110 generates audio with a more tense rhythm to replace the predetermined audio mode of the program. Optionally, when the TV program of the TV program information is a movie program, the audio processing circuit 110 generates audio more appropriate for the viewer to listen to according to the audio mode of the audio mode database 106. The more appropriate audio replaces an original audio of the movie program. Conversely, when the automatic audio adjusting mode is deactivated, the audio processing circuit 110 directly finds the predetermined audio mode from the received multimedia signal and plays the multimedia signal according to the predetermined audio mode.

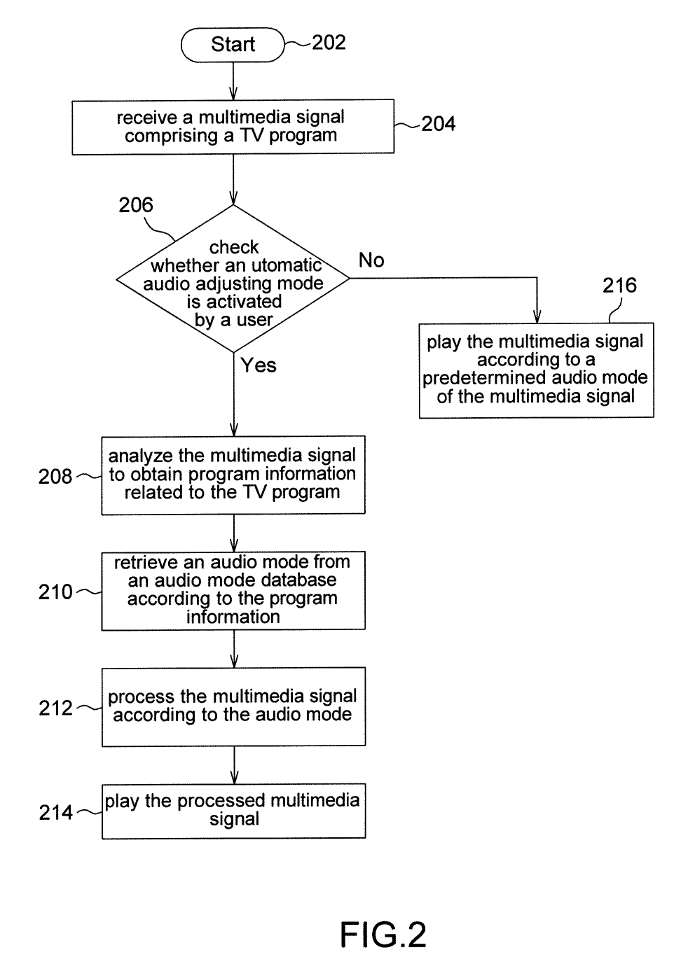

FIG. 2 shows a flow chart of a multimedia playing method according to the present invention. The multimedia playing method begins with Step 202. In Step 204, a multimedia signal comprising a TV program is received. In Step 206, whether an automatic audio adjusting mode is activated by a user is checked. When the automatic audio adjusting mode is activated, Step 208 is executed. Otherwise, Step 216 is performed. In Step 208, the multimedia signal is analyzed to obtain program information related to the TV program. In Step 210, an audio mode is retrieved from an audio mode database according to the program information. In Step 212, the multimedia signal is processed according to the audio mode. In Step 214, the processed multimedia signal is played. In Step 216, the multimedia signal is played according to a predetermined audio mode of the multimedia signal.

It is to be noted that, in a preferred embodiment of the present invention, Step 210 further comprises determining the audio mode retrieved from the audio mode database 106 according to an image characteristic included in the multimedia signal.

A multimedia playing device and a method thereof are provided according to the present invention. A type of a TV program that is part of a multimedia signal is classified by analyzing the received multimedia signal having various kinds of information, such as channel information or a channel identification trademark comprised in an image characteristic of program information. When an automatic audio adjusting mode is activated, the multimedia is played in accordance with an audio mode that is more appropriate for the type of the TV program. The audio mode is selected from an audio mode database according to the type of the TV program. The automatic audio adjusting mode according to the present invention provides better flexibility for a viewer in choosing an audio mode, such that the viewer is able to choose between a predetermined audio mode of the multimedia signal or a preferred audio mode that meets the view's needs in listening to the played multimedia signal.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A multimedia playing method capable of adjusting an audio mode according to a television (TV) program, comprising:
(a) receiving a multimedia signal comprising the TV program;
(b)analyzing the multimedia signal to obtain program information associated with the TV program;
(c) retrieving an audio mode from an audio mode database according to the program information;
(d) processing the multimedia signal according to the audio mode to obtain a processed multimedia signal; and
(e) playing the processed multimedia signal.

2. The multimedia playing method as claimed in claim 1, wherein the program information comprises a channel name of the TV program, the audio mode database stores the channel name and the audio mode corresponding to the channel name, and the audio mode is retrieved according to the channel name in Step (c).

3. The multimedia playing method as claimed in claim 2, wherein Step (b) further comprises:
(b1) analyzing an image characteristic of the TV program to obtain the channel name of the TV program.

4. The multimedia playing method as claimed in claim 3, wherein the image characteristic comprises a channel identification trademark displayed in the TV program.

5. The multimedia playing method as claimed in claim 1, wherein the program information comprises a channel number of the TV program, the audio mode database stores the channel number and the audio mode corresponding to the channel number, and the audio mode is retrieved according to the channel number in Step (c).

6. The multimedia playing method as claimed in claim 1, wherein the multimedia signal further comprises a predetermined audio mode of the TV program, and between Step (a) and Step (b), the multimedia playing method further comprises:
(f) checking whether an automatic audio adjusting mode is activated; and
(g) skipping Step (b) to Step (e) when the automatic audio adjusting mode is deactivated, and playing the multimedia signal according to the predetermined audio mode.

7. A multimedia playing device capable of adjusting an audio mode according to a TV program, comprising:
a receiver, for receiving a multimedia signal comprising the TV program;
an information analyzer, coupled to the receiver, for analyzing the multimedia signal to obtain program information associated with the TV program;
an audio mode database, coupled to the information analyzer, for generating an audio mode according to the program information;
an audio processing circuit, coupled to the receiver and the audio mode database, for processing the multimedia signal according to the audio mode to obtain a processed multimedia signal; and
a playing unit, coupled to the audio processing circuit, for playing the processed multimedia signal.

8. The multimedia playing device as claimed in claim 7, wherein the program information comprises a channel name of the TV program, the audio mode database stores the channel name and the audio mode corresponding to the channel name, and the audio mode database generates the audio mode according to the channel name.

9. The multimedia playing device as claimed in claim 8, wherein the information analyzer analyzes an image characteristic of the TV program to obtain the channel name of the TV program.

10. The multimedia playing device as claimed in claim 9, wherein the image characteristic comprises a channel identification trademark displayed in the TV program.

11. The multimedia playing device as claimed in claim 7, wherein the program information comprises a channel number of the TV program, the audio mode database stores the channel number and the audio mode corresponding to the channel number, and the audio mode database generates the audio mode according to the channel number.

12. The multimedia playing device as claimed in claim 7, wherein the multimedia signal further comprises a predetermined audio mode of the TV program, and when an automatic audio adjusting mode of the multimedia playing device is deactivated, the audio processing circuit processes the multimedia signal according to the predetermined audio mode.

13. The multimedia playing device as claimed in claim 7, wherein the audio processing circuit is an equalizer.
